(19) United States
(12) Patent Application Publication
(10) Pub. No.: US 2014/0078413 A1
(43) Pub. Date: Mar. 20, 2014

(54) LIQUID CRYSTAL DISPLAY STRUCTURE

(71) Applicant: HANNSTAR DISPLAY CORP., NEW TAIPEI CITY (TW)

(72) Inventors: DONG-XIAN YU, NANTOU COUNTY (TW); WEI-CHI LAI, NEW TAIPEI CITY (TW)

(21) Appl. No.: 13/919,124

(22) Filed: Jun. 17, 2013

(30) Foreign Application Priority Data
Sep. 19, 2012 (CN) 201210350957.X

(51) Int. Cl. G02F 1/1333

(52) U.S. Cl. CPC G02F 1/133308; G02F 1/13338
USPC 349/12; 349/58

(57) ABSTRACT

There is provided a liquid crystal display structure including a display unit, a lower frame and a twin adhesive tape. The lower frame includes a bottom plate and a sidewall, wherein the sidewall perpendicularly extends upward from edges of the bottom plate and has an opening. The twin adhesive tape is adhered to the bottom plate of the lower frame inside the sidewall and is configured to combine the display unit with the bottom plate, wherein the twin adhesive tape has an extended part extending out from the opening of the sidewall.

### CROSS REFERENCE TO RELATED APPLICATION

This application claims the priority benefit of Chinese Patent Application Number 201210350957.X, filed on Sep. 19, 2012, the full disclosure of which is incorporated herein by reference.

### BACKGROUND

1. Field of the Disclosure

This disclosure generally relates to a display device and, more particularly, to a liquid crystal display structure capable of improving the rework yield.

2. Description of the Related Art

The display unit of a liquid crystal display is formed by a display panel and a backlight module. The backlight module generally further includes a plurality of components such as a light source, optical films, a light guide plate, reflecting sheets and so on. Therefore, the above components have to be assembled and fastened in manufacturing the liquid crystal display.

FIG. 1 shows an exploded view of the conventional liquid crystal display structure, which includes a display unit 81, an upper frame 82 and a lower frame 83, wherein the upper frame 82 and the lower frame 83 respectively include a joining member 821 and 831 corresponding to each other, and the upper frame 82 and the lower frame 83 are configured to assemble and fasten a plurality of components included in the display unit 81. However, the volume of the liquid crystal display can be increased when using the upper frame 82 and the lower frame 83 to assemble and fasten the display unit 81.

FIG. 2 shows an exploded view of another conventional liquid crystal display structure, which includes a display unit 91, an adhesive 92 and a plastic frame 93, wherein the adhesive 92 is configured to combine the display unit 91 with the plastic frame 93. Since the liquid crystal display structure in FIG. 2 does not have the outer frame, the size of the liquid crystal display structure can be decreased. In order to fasten the display unit 91 to the plastic frame 93 firmly, the plastic frame 93 has a sidewall such that the display unit 91 can be disposed inside the plastic frame 93. However, before the display unit 91 is assembled to the plastic frame 93, the adhesive 92 has to be adhered inside the plastic frame 93 but when the adhesive 92 is not correctly adhered to the predetermined position, the adhesive 92 has to be torn off and pasted again. The sidewall can cause the process of tearing off the adhesive 92 to be difficult to perform. Furthermore, the adhesive 92 may be damaged such that the rework yield is decreased.

Accordingly, the present disclosure further provides a liquid crystal display structure capable of improving the rework yield thereby reducing the manufacturing cost.

### SUMMARY

It is an object of the present disclosure to provide a liquid crystal display structure capable of improving the rework yield.

The present disclosure provides a liquid crystal display structure including a display unit, a lower frame and a twin adhesive tape. The lower frame includes a bottom plate and a sidewall, wherein the sidewall perpendicularly extends upward from edges of the bottom plate and has an opening. The twin adhesive tape is adhered to the bottom plate of the lower frame inside the sidewall and is configured to combine the display unit with the bottom plate, wherein the twin adhesive tape has an extended part extending out from the opening of the sidewall.

In one aspect, a lower surface of the twin adhesive tape has a glueless area and a glued area, wherein the glueless area is at a side closing to or away from a center of the lower frame.

In one aspect, the sidewall has an outer surface, wherein a front surface of the extended part of the twin adhesive tape is aligned with the outer surface or a front end of the extended part of the twin adhesive tape is adhered to the outer surface.

In one aspect, the bottom plate is a rectangle and the sidewall perpendicularly extends upward from four edges of the bottom plate, wherein the opening of the sidewall locates at one of four corners of the rectangle and the twin adhesive tape is adhered to the bottom plate inside the sidewall in a ring shape.

In one aspect, the liquid crystal display structure further includes an outer frame configured to combine with the lower frame so as to assemble and fasten the display unit and the lower frame.

In one aspect, the liquid crystal display structure further includes a touch panel.

In the liquid crystal display structure according to the embodiment of the present disclosure, an opening is formed on the sidewall of the lower frame and an extended part of the twin adhesive tape extends out from the opening served as a holding part. In addition, a lower surface of the twin adhesive tape contains a glueless area such that the twin adhesive tape can be easily torn in the rework process. Accordingly, the reword yield is improved and the manufacturing cost is reduced.

### BRIEF DESCRIPTION OF THE DRAWINGS

Other objects, advantages, and novel features of the present disclosure will become more apparent from the following detailed description when taken in conjunction with the accompanying drawings.

FIG. 1 shows an exploded view of the conventional liquid crystal display structure.

FIG. 2 shows an exploded view of another conventional liquid crystal display structure.

FIG. 3 shows an exploded view of the liquid crystal display structure according to an embodiment of the present disclosure.

FIG. 4A shows an enlarged view of the opening of the sidewall of the lower frame in the liquid crystal display structure in FIG. 3.

FIG. 4B shows another enlarged view of the opening of the sidewall of the lower frame in the liquid crystal display structure in FIG. 3.

FIGS. 5A-5B respectively show a cross-sectional view of the twin adhesive tape of the liquid crystal display structure taken along line V-V′ in FIG. 4.

FIG. 6 shows another enlarged view of the opening of the sidewall of the lower frame in the liquid crystal display structure in FIG. 3, wherein the tearing of the twin adhesive tape is shown.

FIG. 7 shows another exploded view of the liquid crystal display structure according to an embodiment of the present disclosure, wherein the liquid crystal display structure further includes an outer frame and a touch panel.

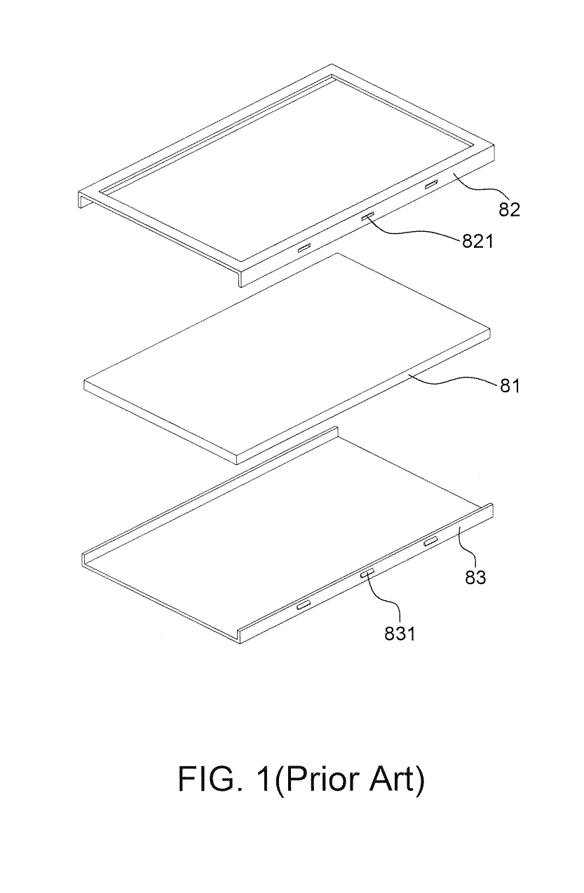

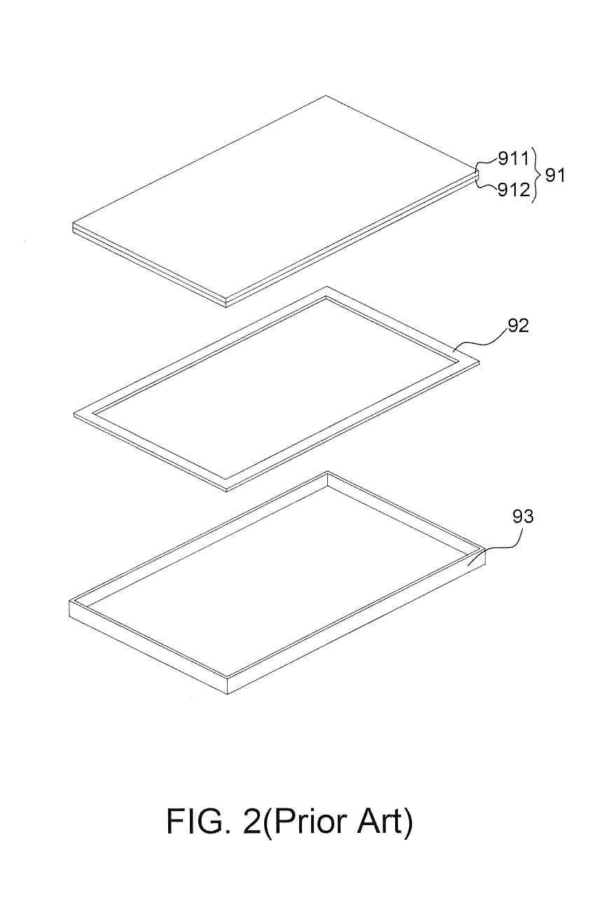

### DETAILED DESCRIPTION OF THE EMBODIMENT

It should be noted that, wherever possible, the same reference numbers will be used throughout the drawings to refer to the same or like parts.

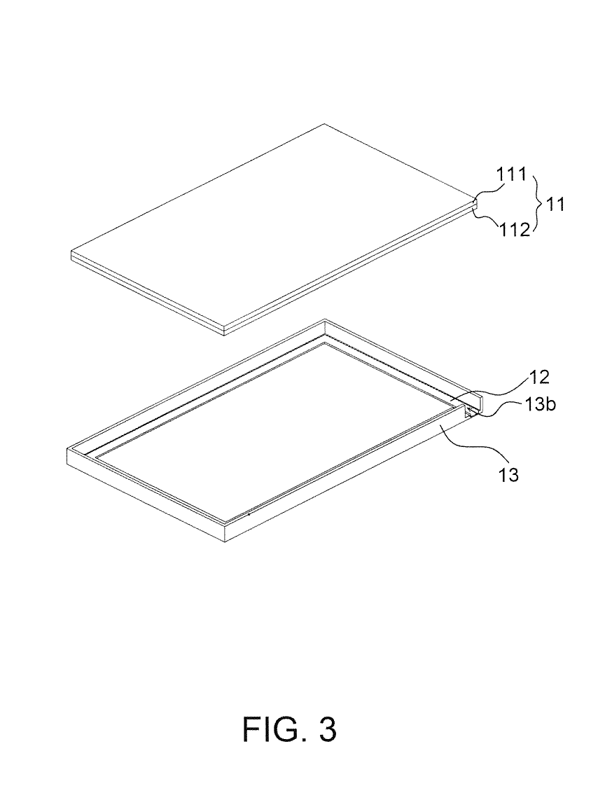

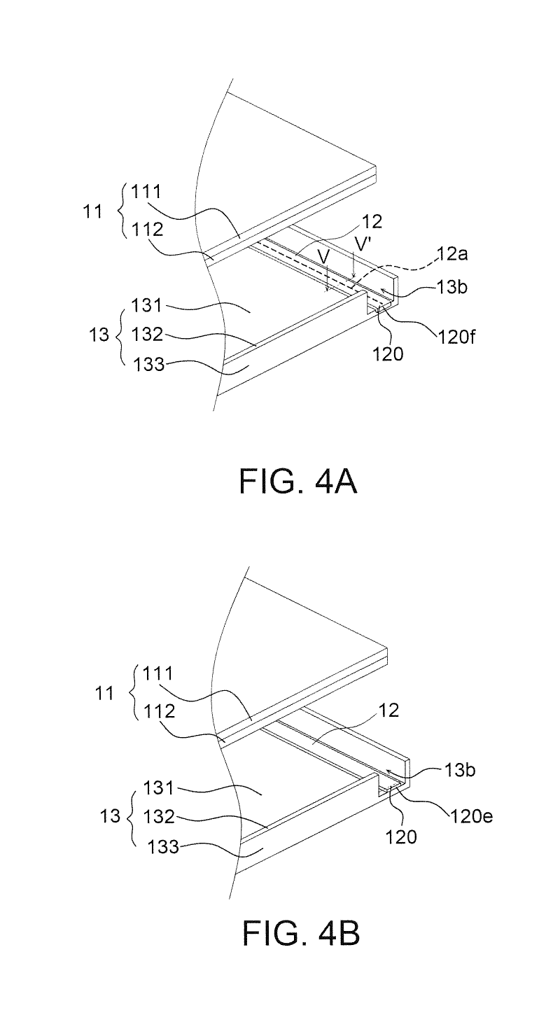

Referring to FIGS. 3, 4A and 4B, FIG. 3 shows an exploded view of the liquid crystal display structure according to an embodiment of the present disclosure; FIGS. 4A and 4B respectively show a partial enlarged view of the liquid crystal display structure in FIG. 3. The liquid crystal display structure of this embodiment includes a display unit 11, a twin adhesive tape 12 and a lower frame 13, wherein the twin adhesive tape 12 is configured to combine the display unit 11 with the lower frame 13. The liquid crystal display structure of this embodiment may be adapted to a direct type liquid crystal display or a side light type liquid crystal display and without any limitation.

For example, the display unit 11 includes a display panel 111 and a backlight unit 112. For example, the display panel 111 may include a color filter substrate, a thin film transistor substrate and a liquid crystal layer sandwiched between the color filter substrate and the thin film transistor substrate, wherein the liquid crystal layer is configured to control the light penetration during displaying images. For example, the backlight unit 112 may include a light source, at least one optical film, a light guide plate and reflecting sheets. Structures of the display panel 111 and the backlight unit 112 are well known and thus details thereof are not described herein. The present disclosure is to improve the rework yield of the liquid crystal display structure in assembling the display unit 11, the twin adhesive tape 12 and the lower frame 13.

The lower frame 13 includes a bottom plate 131 and a sidewall 132, wherein the sidewall 132 perpendicularly extends upward from edges of the bottom plate 131, wherein the term “upward” is referred to a direction adapted to combine the display unit 11. The sidewall 132 is configured to accommodate the display unit 11 inside the lower frame 13 so as to improve the fastening and protection effects. Therefore, an area of the bottom plate 131 may be substantially equal to or slightly larger than that of the display unit 11. In this embodiment, in order to improve the rework yield, the sidewall 132 includes an opening 13b.

In one embodiment, the lower frame 13 has a rectangle shape, and the sidewall 132 has an outer surface 133 and perpendicularly extends upward from four edges of the bottom plate 131. Herein, the opening 13b of the sidewall 132 may locate at one of four corners of the rectangle. In other embodiments, one of the four edges of the bottom plate 131 may not have the sidewall 132 so as to improve the convenience of disposing other components, e.g. a flexible printed circuit board (PCB) may extend out from the edge without the sidewall. That is, the sidewall 132 may only locate at three edges of the bottom plate 131 and extend perpendicularly upward from the bottom plate 131. The opening 13b of the sidewall 132 is formed at one of two corners in the rectangle having the sidewall 132 at two adjacent edges.

The twin adhesive tape 12 is adhered to the bottom plate 131 of the lower frame 13 inside the sidewall 132 and is configured to combine the display unit 11 with the bottom plate 13. In this embodiment, the twin adhesive tape 12 includes an extended part 120 extending out from the opening 13b of the sidewall 132. Therefore, in the rework process, the twin adhesive tape 12 may be torn off from the extended part 120. In one embodiment, a front end 120f of the extended part 120 of the twin adhesive tape 12 may be adhered to the outer surface 133 of the sidewall 132 for fixing thereon (as shown in FIG. 4A), and this has the advantage that the holding part for tearing off the twin adhesive tape 12 in the rework process is long enough. In another embodiment, a front surface 120e of the extended part 120 of the twin adhesive tape 12 is aligned with the outer surface 133 of the sidewall 132 (as shown in FIG. 4B), and this has the advantage that the extended part 120 does not protrude from the sidewall 132. In an alternative embodiment, the twin adhesive tape 12 is adhered to the bottom plate 131 inside the sidewall 132 in a ring shape, and the twin adhesive tape 12 is preferably adjacent to an inner surface of the sidewall 132.

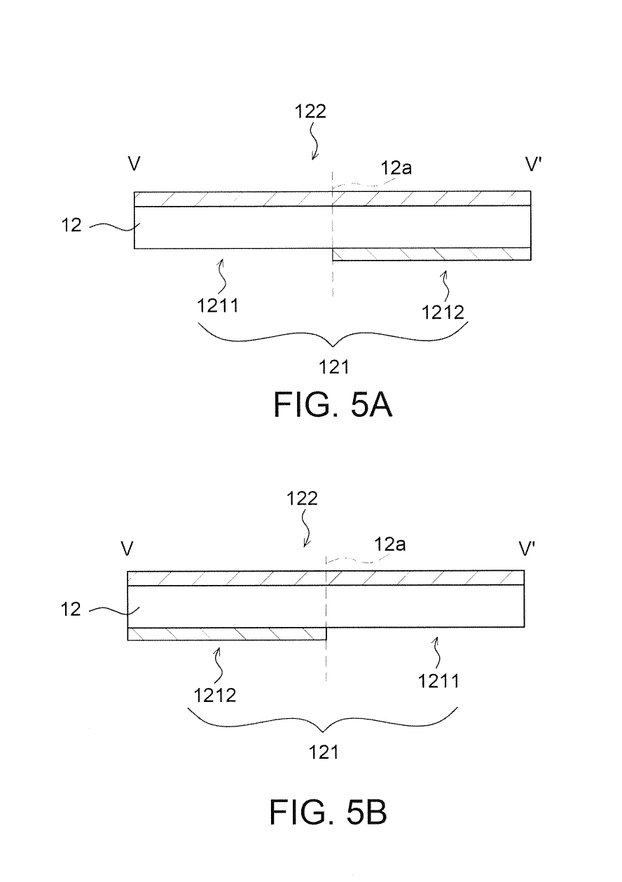

Referring to FIGS. 5A and 5B, in order to further improve the convenience of tearing off the twin adhesive tape 12 in the rework process, a lower surface 121 of the twin adhesive tape 12 may contain a glueless area 1211 and a glued area 1212, wherein an imaginary line 12a is used herein for description purpose. As show in FIG. 5A, the twin adhesive tape 12 has a lower surface 121 and an upper surface 122, and the glueless area 1211 may be at a side closing to a center of the lower frame 13, e.g. in FIG. 5A the left side of the imaginary line 12a is the glueless area 1211 whereas the right side of the imaginary line 12a is the glued area 1212, and the upper surface 122 is coated with adhesive so as to combine with the bottom surface of the display unit 11. As shown in FIG. 5B, the glueless area 122 may also be at a side away from the center of the lower frame 13, e.g. in FIG. 5B the left side of the imaginary line 12a is the glued area 1212 whereas the right side of the imaginary line 12a is the glueless area 1211, and the upper surface 122 is also coated with adhesive so as to combine with the bottom surface of the display unit 11. It should be mentioned that the imaginary line 12a may be the center line of the twin adhesive tape 12, but the present disclosure is not limited thereto.

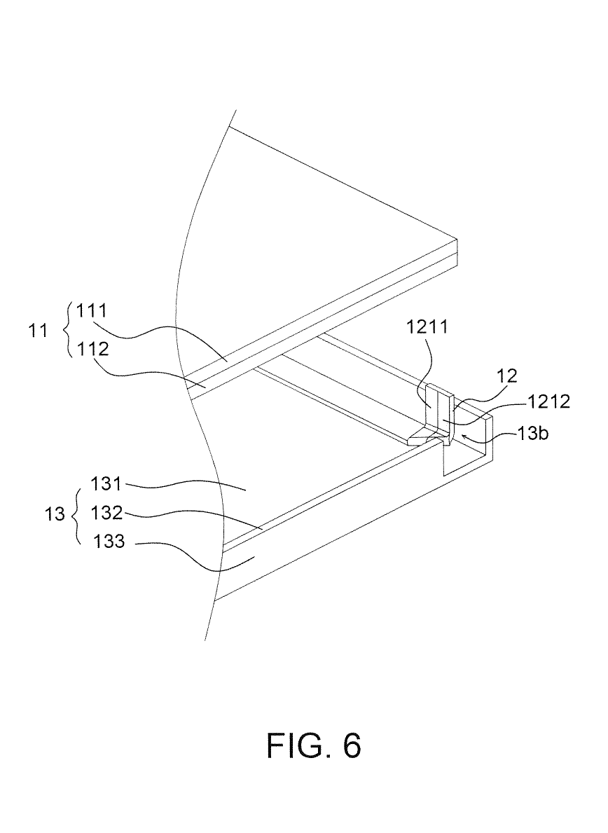

Therefore, as shown in FIG. 6, when the twin adhesive tape 12 is being torn off, the extended part 120 can be held to start the tearing process. As a part of the lower surface 121 of the twin adhesive tape 12 closing to or away from the center of the lower frame 13 does not have adhesive, it is able to prevent the twin adhesive tape 12 from being damaged when it is being torn off.

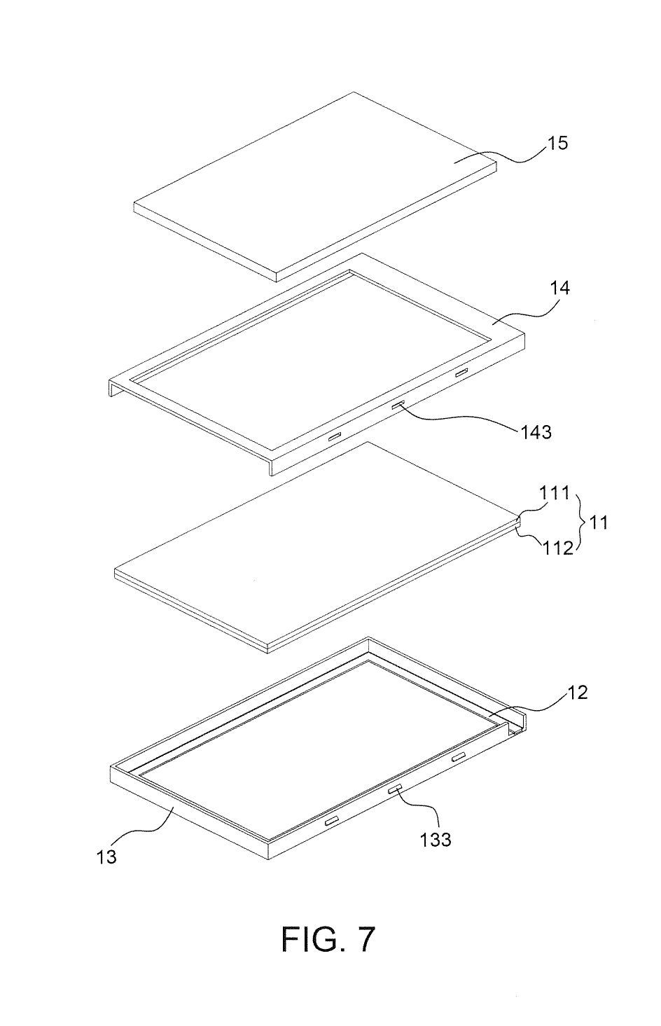

It should be mentioned that the liquid crystal display structure according to the embodiment of the present disclosure is not limited to the structure without the outer frame. As shown in FIG. 7, the liquid crystal display structure according to the embodiment of the present disclosure may further include an outer frame 14 configured to combine with the lower frame 13 so as to further assemble and fasten the display unit 11 and the lower frame 13. It is appreciated that the outer frame 14 and the lower frame 13 respectively include a joining member 143 and 133 for fastening together.

In addition, the liquid crystal display structure according to the embodiment of the present disclosure may be integrated with a touch panel 15 so as to form a touch liquid crystal display. The coupling between the touch panel and the liquid crystal display is well known and thus details thereof are not described herein.

In other words, the liquid crystal display structure according to the embodiment of the present disclosure may be adapted to any liquid crystal display that employs the twin adhesive tape as the assembling means. As the assembling and fastening process using the twin adhesive tape may include the rework process, the rework yield can be improved and the manufacturing cost can be reduced by using the structure according to the embodiment of the present disclosure.

As mentioned above, the conventional liquid crystal display structure has a low yield in the rework process. Therefore, the present disclosure further provides a liquid crystal display structure (FIGS. 3 and 7) in which an opening is formed on the sidewall of the lower frame and an extended part of the twin adhesive tape extends out from the opening such that the extended part may be served as a holding part in tearing off the twin adhesive tape. Furthermore, a part of the lower surface of the twin adhesive tape is not coated with glue so as to improve the convenience of tearing off the twin adhesive tape thereby effectively improving the rework yield and reducing the manufacturing cost.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A liquid crystal display structure, comprising:
a display unit;
a lower frame comprising a bottom plate and a sidewall, wherein the sidewall extends upward from edges of the bottom plate and has an opening; and
a twin adhesive tape adhered to the bottom plate of the lower frame inside the sidewall and having an extended part extending out from the opening of the sidewall, configured to combine the display unit with the bottom plate.

2. The liquid crystal display structure as claimed in claim 1, wherein a lower surface of the twin adhesive tape has a glueless area at a side closing to or away from a center of the lower frame.

3. The liquid crystal display structure as claimed in claim 1, wherein the sidewall has an outer surface and a front surface of the extended part of the twin adhesive tape is aligned with the outer surface.

4. The liquid crystal display structure as claimed in claim 2, wherein the sidewall has an outer surface and a front surface of the extended part of the twin adhesive tape is aligned with the outer surface.

5. The liquid crystal display structure as claimed in claim 1, wherein the sidewall has an outer surface and a front end of the extended part of the twin adhesive tape is adhered to the outer surface.

6. The liquid crystal display structure as claimed in claim 2, wherein the sidewall has an outer surface and a front end of the extended part of the twin adhesive tape is adhered to the outer surface.

7. The liquid crystal display structure as claimed in claim 1, wherein the bottom plate is a rectangle and the sidewall extends upward from four edges of the bottom plate.

8. The liquid crystal display structure as claimed in claim 7, wherein the opening of the sidewall locates at one of four corners of the rectangle.

9. The liquid crystal display structure as claimed in claim 7, wherein the twin adhesive tape is adhered to the bottom plate of the lower frame inside the sidewall in a ring shape.

10. The liquid crystal display structure as claimed in claim 2, wherein the bottom plate is a rectangle and the sidewall extends upward from four edges of the bottom plate.

11. The liquid crystal display structure as claimed in claim 10, wherein the opening of the sidewall locates at one of four corners of the rectangle.

12. The liquid crystal display structure as claimed in claim 10, wherein the twin adhesive tape is adhered to the bottom plate of the lower frame inside the sidewall in a ring shape.

13. The liquid crystal display structure as claimed in claim 1, further comprising an outer frame configured to combine with the lower frame.

14. The liquid crystal display structure as claimed in claim 2, further comprising an outer frame configured to combine with the lower frame.

15. The liquid crystal display structure as claimed in claim 1, further comprising a touch panel.

16. The liquid crystal display structure as claimed in claim 2, further comprising a touch panel.

17. The liquid crystal display structure as claimed in claim 1, wherein the liquid crystal display structure is adapted to a direct type liquid crystal display or a side light type liquid crystal display.

18. The liquid crystal display structure as claimed in claim 2, wherein the liquid crystal display structure is adapted to a direct type liquid crystal display or a side light type liquid crystal display.
